(19) United States
(12) Patent Application Publication
(10) Pub. No.: US 2007/0225994 A1
(43) Pub. Date: Sep. 27, 2007

(54) Method for Providing Private Civil Security Services Bundled with Second Party Products

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/554,452

(22) Filed: Oct. 30, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.
Application No. 11/421,694 is a continuation-in-part of application No. 11/423,594, filed on Jun. 12, 2006.
Application No. 11/423,594 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006.
Application No. 11/456,472 is a continuation-in-part of application No. 11/461,605, filed on Aug. 1, 2006.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.
Application No. 11/462,795 is a continuation-in-part of application No. 11/462,845, filed on Aug. 7, 2006.
Application No. 11/462,845 is a continuation-in-part of application No. 11/464,751, filed on Aug. 15, 2006.
Application No. 11/464,751 is a continuation-in-part of application No. 11/464,764, filed on Aug. 15, 2006.
Application No. 11/464,764 is a continuation-in-part of application No. 11/464,775, filed on Aug. 15, 2006.
Application No. 11/464,775 is a continuation-in-part of application No. 11/464,788, filed on Aug. 15, 2006.
Application No. 11/464,788 is a continuation-in-part of application No. 11/464,799, filed on Aug. 15, 2006.
Application No. 11/464,799 is a continuation-in-part of application No. 11/465,063, filed on Aug. 16, 2006.
Application No. 11/465,063 is a continuation-in-part of application No. 11/466,727, filed on Aug. 23, 2006.
Application No. 11/466,727 is a continuation-in-part of application No. 11/466,953, filed on Aug. 24, 2006.
Application No. 11/466,953 is a continuation-in-part of application No. 11/470,156, filed on Sep. 5, 2006.
Application No. 11/470,156 is a continuation-in-part of application No. 11/531,651, filed on Sep. 13, 2006.
Application No. 11/531,651 is a continuation-in-part of application No. 11/532,461, filed on Sep. 15, 2006.
Application No. 11/532,461 is a continuation-in-part of application No. 11/535,021, filed on Sep. 25, 2006.
Application No. 11/535,021 is a continuation-in-part of application No. 11/535,282, filed on Sep. 26, 2006.
Application No. 11/535,282 is a continuation-in-part of application No. 11/537,469, filed on Sep. 29, 2006.
Application No. 11/537,469 is a continuation-in-part of application No. 11/539,798, filed on Oct. 9, 2006.
Application No. 11/539,798 is a continuation-in-part of application No. 11/539,861, filed on Oct. 9, 2006.
Application No. 11/539,861 is a continuation-in-part of application No. 11/548,191, filed on Oct. 10, 2006.
Application No. 11/548,191 is a continuation-in-part of application No. 11/549,874, filed on Oct. 16, 2006.
Application No. 11/549,874 is a continuation-in-part of application No. 11/550,594, filed on Oct. 18, 2006.
Application No. 11/550,594 is a continuation-in-part of application No. 11/551,083, filed on Oct. 19, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,820, filed on Oct. 2, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.
(60) Provisional application No. 60/829,447, filed on Oct. 13, 2006.
(60) Provisional application No. 60/829,779, filed on Oct. 17, 2006.
(60) Provisional application No. 60/862,398, filed on Oct. 20, 2006.
(60) Provisional application No. 60/862,718, filed on Oct. 24, 2006.

(51) Int. Cl. G06Q 10/00; G06Q 30/00

(52) U.S. Cl. 705/1

(57) ABSTRACT

A first party provides private civil security resources that comprise, at least in part: civil security provisions, civil security facilities, and civil security services. The first party also knowingly permits a second party to offer a product bundle that comprises at least one second party product and at least partial payment for consideration-based access to the private civil security resources. The access to the private civil security resources is provided for potential authorized beneficiaries as an incentive for the potential authorized beneficiaries to obtain the at least one second party product.

### RELATED APPLICATIONS

This application claims the benefit of the filing date of U.S. provisional application Nos. 60/820,628 filed on Jul. 28, 2006, 60/823,806 filed on Aug. 29, 2006, 60/825,524 filed on Sep. 13, 2006, 60/825,976 filed on Sep. 18, 2006, 60/826,491 filed on Sep. 29, 2006, 60/827,591 filed on Sep. 29, 2006, 60/827,820 filed on Oct. 2, 2006, 60/827,828 filed on Oct. 2, 2006, 60/828,341 filed on Oct. 5, 2006, 60/828,342 filed on Oct. 5, 2006, 60/829,447 filed on Oct. 13, 2006, 60/829,779 filed on Oct. 17, 2006, 60/862,398 filed on Oct. 20, 2006, 60/862,718 filed on Oct. 24, 2006, 60/863,292 filed on Oct. 27, 2006, which are hereby incorporated in their entirety herein.

This application comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464,751;

PRIVATELY PROVISIONED SURVIVAL SUPPLIES SUB UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY as filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB UNIT BASED SURVIVAL SUPPLIES PROVISIONING METHOD as filed on Sep. 25, 2006 and having application Ser. No. 11/535,021;

RESOURCE CONTAINER AND POSITIONING METHOD AND APPARATUS as filed on Sep. 26, 2006 and having application Ser. No. 11/535,282;

PUBLICLY-FUNDED PRIVATELY FACILITATED ACCESS TO SURVIVAL RESOURCES METHOD as filed on Sep. 29, 2006 and having application Ser. No. 11/537,469;

ELECTRICITY PROVIDING PRIVATELY PROVISIONED SUBSCRIPTION-BASED SURVIVAL SUPPLY UNIT METHOD AND APPARATUS as filed on Oct. 9, 2006 and having application Ser. No. 11/539,798;

PREMIUM-BASED CIVILLY-CATASTROPHIC EVENT THREAT ASSESSMENT as filed on Oct. 9, 2006 and having application Ser. No. 11/539,861;

PRIVATELY MANAGED ENTERTAINMENT AND RECREATION SUPPLIES PROVISIONING METHOD as filed on Oct. 10, 2006 and having application Ser. No. 11/548,191;

METHOD TO FACILITATE PROVIDING ACCESS TO A PLURALITY OF PRIVATE CIVIL SECURITY RESOURCE as filed on Oct. 16, 2006 and having application Ser. No. 11/549,874;

METHOD OF PROVIDING BEARER CERTIFICATES FOR PRIVATE CIVIL SECURITY BENEFITS as filed on Oct. 18, 2006 and having application Ser. No. 11/550,594;

METHOD FOR CIVILLY-CATASTROPHIC EVENT-BASED TRANSPORT SERVICE AND VEHICLES THEREFOR as filed on Oct. 19, 2006 and having application Ser. No. 11/551,083;

the contents of each of which are fully incorporated herein by this reference.

### TECHNICAL FIELD

This invention relates generally to providing private civil security resources.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or non-naturally-caused events can sufficiently disrupt society's infrastructure and ability to provide one or more life-sustaining resources such as provisions like hydration and nutrition, services like transportation, facilities like shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

As a result, many (if not most) individuals and their families are largely bereft of access to survival resources that they will need should a civilly-catastrophic event befall them. This shortcoming tends to be relatively comprehensive; most people do not have ready access to emergency survival supplies, services or facilities. For people who do have such a store of supplies set aside or do have contingency arrangements for transportation and shelters for such an eventuality, it can be a considerable burden to maintain and ensure the freshness, vitality, and/or usability of those resources. At the same time, the same civilly-catastrophic event that occasions their need for such resources will also likely disrupt relevant infrastructure and supply chains enough to cause a partial or complete shortage of resources. The unfortunate net result is a relatively near-term severe need for a variety of civil security survival resources that will often go unmet for lengthy periods of time.

### BRIEF DESCRIPTION OF THE DRAWINGS

The above needs are at least partially met through provision of the premium-based private civil security policy methods described in the following detailed description, particularly when studied in conjunction with the drawings, wherein:

FIG. 1 comprises a flow diagram as configured in accordance with various embodiments of the invention; and

FIG. 2 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a first party provides private civil security resources (also referred to herein as defense benefits). By one approach, the private civil security resources comprise, at least in part, civil security provisions, civil security services, and civil security facilities. The first party also knowingly permits a second party to offer a product bundle that comprises at least one second party product and at least partial payment for consideration-based access to the private civil security resources provided by the first party. The access to the private civil security resources is offered to potential authorized beneficiaries as an incentive for the potential authorized beneficiaries to obtain the at least one second party product. By an alternative approach, the reverse may be offered where the first party offers a second party product as an incentive for obtaining the private civil security resources.

So configured, authorized beneficiaries of such consideration-based private civil security resources will have concrete, predictable access to survival resources upon the occurrence of a triggering incident such as, in one example, the occurrence (and/or threat) of a civilly-catastrophic event. The selection and quantity of emergency private civil security resources can be generally selected (and their maintenance governed) by experts and hence relieve the authorized beneficiary of responsibility in this regard.

The aforementioned second party can comprise any of a wide variety of business entities that offer and/or provide a second party product (also referred to hereinafter as the “product”) that may tangible or intangible. By one approach, the second product may be one that suggests a relation to civil security resources, or may be a product that is directed toward a market known to attract people who can afford the private civil security resources, as explained below. The approach using second parties to bundle the civil security resources, in turn, permits a large existing infrastructure to be leveraged in favor of vetting the civil security resources provided by the first party and advising and marketing to a large existing audience with respect to the value and availability of such civil security resources.

These steps are readily facilitated without dependency upon governmental oversight, participation, or control (though in some embodiments it may be necessary to receive, for example, the approval of state-based industry regulators depending on the second party involved). The particular resources provided can vary with the needs and requirements of the authorized beneficiaries. Importantly, via these teachings individuals can benefit from a greatly increased opportunity to bring a considerably improved measure of security into their lives, knowing that, should a civilly-catastrophic event or other incident indeed be visited upon them, they will have extraordinary and reliable access to private civil security resources.

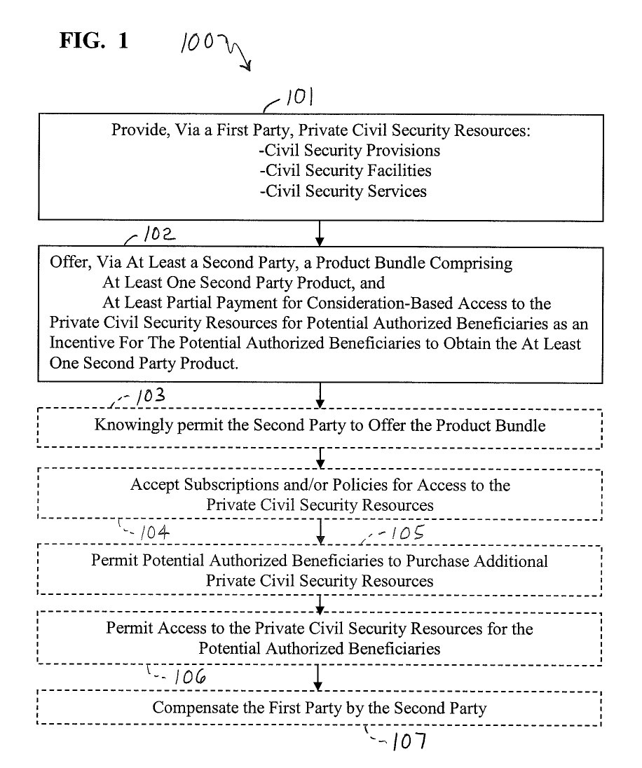

These and other benefits may become clearer upon making a thorough review and study of the following detailed description. Referring now to the drawings, and in particular to FIG. 1, a corresponding process 100 provides 101, via a first party, private civil security resources. This first party can comprise, for example, one provider, or a group of providers, of private civil security resources to various parties under various approaches in addition to those set forth herein. By this approach, the first party therefore comprises an expert with respect to identifying, acquiring, aggregating, storing, maintaining, and providing a variety of civil security resources.

The private civil security resources can vary to some degree with respect to category and kind of resource. By one approach, however, such private civil security resources will comprise, at least in part, civil security provisions, civil security facilities, and civil security services. As used herein, “private” will be understood to refer to the opposite of public ownership or control (as exemplified by governmental or ecclesiastical ownership or control) but can include such things as ownership or control via publicly traded ownership (via, for example, publicly traded stock or the like), ownership or control via a not-for-profit entity, or the like.

Generally speaking, both the civil security provisions and civil security facilities are physical components rather than virtual components or products of the intellect. For example, the civil security provisions will typically comprise physical support and/or protection of one kind or another. Similarly, the civil security facilities will also typically comprise physical assets such as, but not limited to, physical shelters that provide real, substantive physical protection from physical threats to human life. The civil security services can comprise either physical, real world services, or virtual-content services. These private civil security resources are described in great detail in commonly owned U.S. patent application Ser. No. 11/549,874, which is fully incorporated herein, and therefore, great detail is not necessary here. The following, however, is a general description of the possible private civil security resources that could be provided by the first party.

By one approach, the civil security provisions may comprise: a life-sustaining resource such as breathable air (oxygen providing mechanisms for example), water or other fluids, food, protective clothing, a collapsible shelter, medical supplies, personal hygiene supplies, and/or environmental threat abatement supplies (gas masks for example), a communication device, an item for barter to name a number of examples. The civil security provisions here may refer to any provisions provided by the first party. Thus, though a luxury item may technically be referred to as a “non-civil security” provision since it is not necessary to sustain life of an authorized beneficiary, for the purposes of at least this particular application the civil security provisions may include a luxury (which may be anything from books and games to jewelry to name a few examples).

The civil security facilities may comprise a civil security shelter, a rally point at which the authorized beneficiaries can gather in response to a civilly-catastrophic event in order to receive the civil security services, a location where at least some of the authorized beneficiary's civil security provisions are available, a trans-shipment facility for at least some of the civil security provisions, and/or a medical services facility to name a few examples.

Some examples of the civil security services comprise transportation away from a location that substantially lacks civil security and/or transportation to a civil security facility. The services may also include provision of civil security information. In one example, information is provided for one or more authorized beneficiaries including contingency instructions to guide the authorized beneficiaries during a time of need when responding to a civilly-catastrophic event. The information may be provided by a membership services resource in the form of a physical location and/or call-in service. Such a location or service may provide members or authorized beneficiaries with help, advice, subscriber or policy services, customer and/or client relations, and so forth. Other civil security services may include, but are not limited to:

civil security preparedness training;

a long distance communications service that is configured and arranged to provide persistent communication services notwithstanding interaction of the long distance communication service with effects of a civilly-catastrophic event;

a rescue service to retrieve selected beneficiaries from dangerous circumstances owing, at least in part, to a substantial lack of civil security;

delivery of at least a portion of the civil security provisions;

transport of dispossessed persons;

physical security;

medical services;

post-civilly-catastrophic event social relationship facilitation;

delivery of fuel (such as for a vehicle for example); and/or

installation of independent utilities facilities.

This process 100 then provides for offering 102, via a second party, a product bundle comprising at least one second party product and at least partial payment for consideration-based access to the private civil security resources for potential authorized beneficiaries. By this approach, the access to the private civil security resources is provided as an incentive for the potential authorized beneficiaries to obtain at least one second party product. Thus, the second party may offer the access to at least a portion of the civil security resources substantially for “free” where no additional costs are visible to the authorized beneficiaries. Alternatively, the second party may offer to pay for a portion (or all) of the costs of the access to the civil security resources. In either case, the second party may absorb the costs and/or raise the cost on the second party product and/or other products to offset the costs for the civil security resources to its customers.

By one approach, the first party knowingly permits 103 the second party to offer the private civil security resources in a product bundle with the second party's product. This is satisfied as long as the first party has knowledge that the second party, or parties associated with the second party, is paying for the private civil security resources rather than the authorized beneficiary, and that the first party acquiesces to such acts by, for example, accepting payment and/or providing access to the private civil security resources for the authorized beneficiaries.

By one approach, the offer of access to the private civil security resources includes an offer to provide bearer certificates, coupons, gift cards, and so forth. Such certificates may or may not limit the amount and type of civil security resources that will be provided, either fully paid for or at a discount, as the first party allows. Commonly owned U.S. patent application Ser. No. 11/550,594, listed above, describes such certificates in detail and is fully incorporated herein.

The second party can comprise a fully legally independent entity with respect to the first party mentioned above. If desired, however, this second party can be partially (though likely not fully) owned and/or controlled by the first party. In the latter case, for example, the second party may comprise a joint venture or partnership having the first party as a salient participant. The second party, however, may be any business entity such as corporations, individuals, small businesses, profit or non-profit organizations, manufacturers, and/or product sellers (such as retailers, wholesalers, and so forth).

By one approach, the second party may be selling a product that has a characteristic that suggests a general or specific relation with civil security resources (or to a particular resource that is being offered as the giveaway). For example, an insurance seller or underwriter (explained in greater detail below) or other institutions may be selling insurance policies that might be needed in light of damage caused by a civilly-catastrophic event where the same event may activate the need for emergency civil security resources. In this case, the second party product may be insurance policies covering life, health, disability, home, general liability, and/or the occurrence of a particular disaster such as fire, flood, earthquakes, hurricanes, tornados, terrorism, and so forth.

While access to the civil security resources may be generally limited to at least an imminent threat of a civilly-catastrophic event as just described, if desired, the civil security resources may be limited even farther to relate more directly to the second party product that suggests the resources. For instance, fire insurance may be offered with fire related civil security resources such as fire extinguishing protection or provisions; home owner's insurance may be offered with civil security services that include emergency shelter; vehicular insurance may be offered with emergency transportation service; business interruption insurance may be offered with emergency shelter service tailored to maintain the business. Many other examples exist.

It will be understood that almost any product may at least generally suggest some sort of civil security resource. For example, a product such as a vehicle may suggest safety or survival transportation provisions; clothing may suggest protective or emergency clothing provisions; a water softener may suggest emergency potable water provision; and any product that could relate to human, or animal, survival may suggest an emergency substitute civil security resource for that product. Many other examples, no doubt, exist.

Of course, the second party product may have little to do with the private civil security resources. Thus, second party products may be simply those marketed to potential authorized beneficiaries who are known to have the finds to afford a wide range of private civil security resources. In one instance, the product may be any luxury. In other cases, the second party may be a seller or underwriter of insurance. Thus, the second party product may be an annuity plan, a worker's compensation plan, a board of directors' liability, differences, errors, and omissions insurance policy, an all-in-one insurance policy, and so forth.

Along this line, other second parties may be a bank or other financial product institution, a financial advisor, a market maker, or a brokerage firm to name but a few examples. In such cases, the product they sell may include or have an account for funds. (Herein, the terms “sell” and “purchase” refers to any barter or exchange for consideration including where the seller or a party associated with the seller receives fees for managing the product. Thus, in one instance, the product “sold” may be a deposit account where the second party “seller” receives consideration through management fees related to the deposit account.)

More specifically, the second party product may include any type of financial protection, budget, and/or investment product, for example, such as an insurance policy, a financial savings product, a financial planning product, a financial service product, a derivative financial product, a legal services product, a property investment, real estate, and/or a debt product such as bonds, to name a few examples. When the second party is a financial business, a financial products institution, or bank, for example, the second party product may be a financial product such as a deposit account as mentioned above (such as for savings deposits, certificates of deposit, and so forth), a checking account, a savings account, a money market fund, a mutual fund, a hedge fund, a stock-based product, a bond-based product, a retirement savings account (such as a 401K account or an individual retirement account (IRA) for example), a credit card, a line of credit, a mortgage, a revolving loan, financing or a loan for a vehicle or an asset, a debit card, an automatic transaction machine (ATM) card, working capital financing, merchant bank services, payroll services, trust services, electronic commerce (E-commerce) products (such as transactions to be performed over the Internet for example), cash management services, brokerage services, leasing services, annuity management and payment, foreign exchange services, letters of credit, overdraft banking services, bill payment services, on-line bill payment capability, security safe keeping, stock registration, and any other financially related product. In these cases, the second party may require a minimum deposit amount or minimum usage amount, rather than an express, specific amount of consideration, in order to be offered the free civil security resources.

Other examples of a second product include any service, a membership in any club, association, or organization, a commodity, any manufactured article (for example, toasters, cars, computers, and so forth), a purchasable object such as art, any household objects (including any home related object from furniture and ovens to a home security alarm system to name a few examples), any other tradable object, and any combination thereof.

By another approach, the second party is an inter-market entity or inter-dealer entity that sells, buys, barters, and/or trades access to the private civil security resources with third parties, authorized beneficiaries that comprise an organization or business entity, or third parties with authorized beneficiaries, which may or may not be other inter-market or inter-dealer parties. Such second parties may conduct transactions where the access to the private civil security resources is the primary entity being traded or where it is a part of a larger transaction with one of many different things being traded and/or purchased.

In these cases, the second party may be called a “Provider of Coverage” and a “client” of the first party. The second party may then have transactions with authorized beneficiaries, third parties, and/or second parties such as the following:

a counterparty (such as organizations obligated to deliver goods or services pursuant to an executed contract, such as when the non-performance of such contract is material to the second party-Provider of Coverage, to name but one example);

a clearing firm or entity (such as a firm that provides settlement and clearing functions to the second party-Provider of Coverage, when the amounts in question are material to the liquidity of the Provider of Coverage, to name but one of many examples);

an essential functions entity (such as an entity that assists the Provider of Coverage to conduct business in the ordinary course, such as to conduct continuing operations, to name one possible example);

a portfolio Organization (such as businesses owned in whole or in part by the Provider of Coverage, when the value of such organization is material to the value of the Provider of Coverage and its ongoing operations, to name one example); and

a client (such as a specific organization or individual, when the revenue or assets associated with such a client are material to the financial performance of the Provider of Coverage, to name but one possible example).

This process 100 also may include accepting 104 subscription-based and/or policy-based (for example premium-based) consideration for access to the private civil security resources. More specifically now regarding the policy-based consideration, by one approach, selling or providing the access to the private civil security resources, whether bundled with another product or provided alone, may be thought of as providing an allotment of the private civil security resources. Thus, a second party offering the private civil security resources may be an underwriter. Those skilled in the art will understand that “underwriting” refers to the process that a large financial service provider (such as a bank, insurer, investment house, or the like) employs to assess the process of providing access to their products (such as equity capital, insurance, credit, and so forth) to a customer. In a very broad sense, underwriting involves the process of accepting the responsibility (and corresponding risk) of providing or selling a particular allotment of some corresponding proposal, service, or undertaking.

With this in mind (but without intending any particular limitation in this regard), suitable second parties might comprise such entities that already perform at least some underwriting procedures, some of which have already been mentioned above, such as insurance underwriters, financial products institutions, insurance brokers, banks, credit unions, academic institutions or clubs, a certified financial planner, a licensed securities dealer, a religious organization, a trade organization, or a fraternal organization to note but a few examples in this regard. In this case, the second party underwriter would agree to pay, or pay a portion of, the premium for a policy for private civil security resources provided by the first party. The details of such a structure with premium-based access to a policy of private civil security resources is fully explained by commonly owned U.S. application Ser. No. 11/466,953, which is fully incorporated herein and is listed above, and need not be explained further.

The present teachings will also optionally accommodate permitting the second party to provide the potential authorized beneficiaries with subscriptions for access to the private civil security resources. In this case, the second party and/or authorized beneficiaries would be responsible for paying a periodic subscription fee. By one approach, the first party, or parties associated therewith, accepting the subscriptions may be, for example, a for-profit business. By another approach, the first party is a not-for-profit business (such as a membership-based-entity) since it may be the more appropriate entity to offer and accept such subscriptions. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extend past the death of a named subscription beneficiary and further provides for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a one-time-only right of access or a perpetual right of access that may be retained, transferred, inherited, or the like);

ownership-based rights of access (as may occur when the subscription provides for ownership rights with respect to the civil security resources, when the subscription is based upon shareholder-based ownership of the provider of such civil security resources, or the like);

non-transferable rights of access (as may occur when the subscription, by its terms and conditions, prohibits transfer of the right of access to the civil security resources from a first named beneficiary to another);

transferable rights of access (as may occur when the subscription, by its terms and conditions, permits conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided interest by and between multiple subscription beneficiaries with respect to a right to access the civil security resources);

non-ownership based rights of access (as may occur when the subscription, by its terms and conditions, establishes the aforementioned right of access via, for example, a lease, a rental, or borrowing construct);

option-based rights of access (as may occur when the subscription, by its terms and conditions, establishes a right for an authorized beneficiary to later obtain access to some or all such civil security resources upon, for example, paying an additional supplemental amount at that time); and/or

credit-based rights of access (as may occur when a given individual predicates their right to access the civil security resources upon a representation, promise, or other credit-based transaction).

No matter the form of the agreement for the access to the private civil security resources, it will be understood, of course, that the first party may permit 105 an authorized beneficiary to pay his or her own private civil security resources above and beyond what the second party is paying for. This may occur when the authorized beneficiary believes the amount or type of access to the civil security resources paid for or financed by the second party is not adequate for his or her needs.

Whether a subscription, policy, or other instrument, if desired, a plurality of differentiated opportunities can be offered in this regard. This plurality of differentiated opportunities can correspond, for example, to providing access 106 to differing selections and/or quantities of the civil security resources. As but one very simple illustration in this regard, such opportunities can differ from one another at least with respect to cost. This, in turn, provides second party, authorized beneficiary, policy holder, or subscriber choice with respect to selecting a particular package that best meets their specific needs and/or budget limitations.

These teachings also readily encompass the notion of an authorized beneficiary (or buyer of the second party product) indicating an authorized beneficiary other than themselves. Such might occur, for example, when one family member procures access to the civil security resources for one or more other family members. Another example would be for a company to purchase one or more second party products and receive a subscription, for example, on behalf of named key employees, family members of such key employees, and so forth. Other examples no doubt exist. For example, a bearer certificate (or its legal or functional equivalent, such as a gift card) could serve to identify any individual who produces and bears that certificate as an authorized beneficiary.

By one approach, such access 106 can be provided at the whim and convenience of either the second party or the authorized beneficiaries. If desired, however, such access can be further conditioned in appropriate ways. For example, for many purposes and certainly as pertains to many of the civil security resources, it may by appropriate to ordinarily limit such access to situations where such access is triggered, at least in part, by a civilly-catastrophic event having occurred or being likely imminent. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice (such as a particular level or degree of harm, interference, or negative impact upon a given minimum number of people). In addition, or in lieu thereof, such access may be predicated, if desired, upon a requirement of a particular level of objectivity or subjectively ascertained likelihood that a particular category or kind of civilly-catastrophic event will occur within a particular period of time.

As used herein, “civilly-catastrophic event” will be understood to refer to an event that substantially and materially disrupts a society's local, regional, and/or national infrastructure and ability to provide in ordinary course for at least one life-sustaining resource. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation (or worsening) of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geophysical or geological events (such as earthquakes, volcanic activity, and so forth), extreme space-based or astronomical events (such as collisions with comets, large asteroids, and so forth, extreme solar flares, and the like), extreme environmental events (such as widespread uncontrolled fire or the like), and global or regional pandemics or disease-based events, to note but a few.

Examples of non-naturally-caused disasters capable of initiating a civilly-catastrophic event include both unintended events as well as intentional acts of aggression such as war, terrorism, madness, or the like. Examples of non-naturally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, exposure to a harmful mutagenic influence, and so forth.

By one approach, when access to the private civil security resources is restricted to association with a civilly-catastrophic event, and when and if such an applicable event is at least imminently threatened to occur during the coverage period provided by the foregoing private civil security subscriptions or policies, these teachings then provide for permitting the authorized beneficiary to access the private civil security resources. If desired, this can comprise, in part, first (and/or secondly) confirming that the authorized beneficiary is presently authorized to access these resources. Such a determination can be the responsibility of either the first party or the second party as may be agreed to between the two parties. One such process for such a determination is also explained in detail in commonly owned U.S. application Ser. No. 11/466,953, which is fully incorporated herein and is listed above, such that no further description is necessary.

By a further approach, substantially all access to the private civil security resources is handled by the first party. Thus, after an authorized beneficiary is approved for receiving such access, the authorized beneficiary communicates with the first party to provide instructions as to which resources are desired, and to receive instructions from the first party as to which resources will be provided and how they will be provided. By an alternative approach, the second party and/or its associated parties may be involved in any of these steps. By one example, the first party gives the second party civil security provisions for the second party to hand to, or deliver to, the authorized beneficiaries. Many other examples are contemplated.

The process 100 also provides for compensating 107 the first party with respect to having permitted such authorized beneficiaries to access the private civil security resources. Such an action can be prompted, for example, by having the first party provide notice to the second party regarding the authorized beneficiary's access to the private civil security resources. Such notice can be provided on an individual basis or, if desired, can be submitted in some aggregated form. Such compensation may comprise a one-time lump sum payment or a periodic fixed payment such as a flat rate, where either payment type covers all of the access activity of a given authorized beneficiary. This may be, in one example, a payment of a portion of a membership in an organization or a club. The second party may also pay a quasi-flat rate or periodic variable payment (as might correspond, for example, to a per diem-styled form of compensation), or by any other period that may reflect an amount of the actual usage the authorized beneficiary has made of the civil security resources. In such a case, the second party may agree to only make payments during a predetermined time period that corresponds to a time period that the authorized beneficiaries have access to the civil security resources.

By another approach, payment may also be based on a barter exchange between the first and second parties. In this case, the second party may provide the second party products or other products to the first party, the first party's employees, and/or those associated with the first party in exchange for the access to the private civil security resources. It will be understood that such an exchange may have many different structures.

Many other terms for payment of the private civil security resources may be desired by the first or second party. By one approach, the second party offers to pay for any of, or any access to, the private civil security resources that a particular authorized beneficiary desires or uses. The second party may limit such a term with a predetermined maximum payment amount that they will provide to cover the access to the civil security resources. Similarly, the first or second party may provide one or more predetermined packages that include pre-selected particular types or kinds of civil security resources where each package has a particular predetermined cost that the second party has agreed to pay. If more than one package is available, the authorized beneficiary may be provided with the option to choose one or more of the packages.

By one approach, the compensation for the access to the civil security resources is provided directly to the first party from the second party. This would likely ease the burden that might be faced by a given authorized beneficiary to present an adequate payment during a time of need. If desired, however, this compensation can be provided directly (in part or in whole) by the authorized beneficiary to the first party. In such a case, the authorized beneficiary might then have a right (as per the terms of an agreement with the second party) to seek full or partial reimbursement from the second party for such an expenditure. It will also be understood that the plan for compensation may have many other structures such as the use of promissory notes, partial payment plans, and so forth.

By another approach, the second party may have third party agents whether considered quasi-employees of the second party or third party independent contractors. These third parties may interact with candidate or potential authorized beneficiaries and arrange for the product bundle and the access to the first party civil security resources. Such agents or third parties could then receive a commission for selling the access to the civil security resources whether paid by the first and/or second party. Payment for the access to the resources may also be conducted through the third party instead of directly from the second party. There are numerous known legal and physical constructs to facilitate the establishment and use of such agents and brokers. As such approaches are well known, and further as the present teachings are not particularly sensitive to the selection of any particular approach in this regard, for the sake of brevity further elaboration will not be presented here.

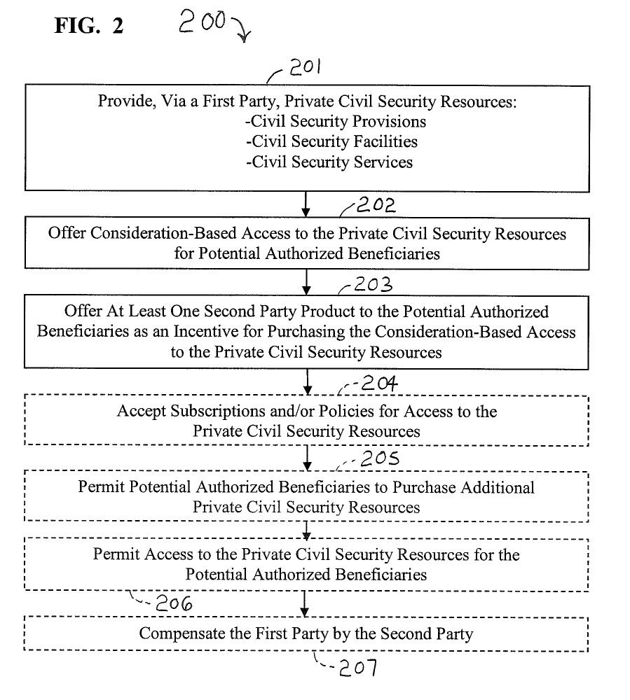

Referring now to FIG. 2, the illustrated process 200 provides for the first party (including any authorized party associated therewith, for example) providing 201 the civil security resources and offering 202 consideration-based access to the private civil security resources as already described above. While the approach described above, however, uses the civil security resources as an incentive to sell a product of a second party, by an alternative or additional approach, the first party may offer 203 the second party product as the incentive for selling access to the private civil security resources instead.

With this approach, the second party product and the second party providing the product may those previously described above. Thus, a second party product, such as hurricane insurance, may be provided for a purchaser of access to civil security facilities for providing a safe shelter during a hurricane, as one possible example. Again, many other examples exist.

The first party may provide the second party product to the authorized beneficiaries for substantially free, or at least absorbed into the other costs for the private civil security resources. Alternatively, the first party may pay a portion of the cost of the second party product and offer the product to the authorized beneficiaries based on a reduced cost. The first party may accept 204 subscription-based access or policy-based access that is fully or partially purchased by the second party as described above, and the authorized beneficiaries may purchase 205 access to more or different private civil security resources above that which is provided by the second party, also similar to that described above for the process 100.

The first party may then permit 206 access to the authorized beneficiaries upon at least an imminent threat of a civilly-catastrophic event as already described above. Regardless of a civilly-catastrophic event, the first party may offer the second party product only if the authorized beneficiary purchases access to the private civil security resources for a minimum predetermined amount of time, a minimum predetermined amount of private civil security resources, a minimum predetermined cost of private civil security resources, one or more predetermined packages of private civil security resources, and/or a particular private civil security resource.

Of course, as mentioned above, the authorized beneficiaries may be permitted 206 to purchase more private civil security resources than is needed to obtain the free second party product. The authorized beneficiaries may also be permitted to purchase more of the second party product than that provided substantially for free or with discount by the first party.

By one approach, the first party compensates 207 the second party for the second party product. The first party may pay a one-time lump-sum fee for the second party product. Alternatively, the first party may provide payments for the second party product for a predetermined amount of time when applicable. This may occur when the second party product is an insurance policy, a membership to a club, or any other product that is paid for using periodic payments. Such a periodic payment may be a fixed payment or may be a variable payment when the payment is based on variable use of the second party product by the authorized beneficiaries.

Those skilled in the art will recognize and appreciate that the above described teachings can be applied and leveraged in a variety of ways to achieve a significant number of tangible and concrete benefits (including but not limited to facilitating a relatively higher degree of potential authorized beneficiary awareness, a relatively higher level of resources availability, and/or a relatively more powerful set of motivations for various parties to adopt behaviors that in turn prompt an increased availability of potentially life-preserving resources for a relatively wide consuming audience than might likely be achieved in the absence of such teachings).

These teachings also permit existing business infrastructures and legacy-based relationships to be readily applied towards the offering and support of a completely new service; i.e., the provisioning of private civil security resources. When offered through parties who are already experienced with the offering of other kinds of protective services and products (such as insurance, wealth protection instruments and plans, and so forth), one may reasonably expect that the offering of private civil security benefits will comprise a relatively natural fit and/or extension of such legacy offerings. This, in turn, can provide a powerful instrument to facilitate generating interest in a completely new kind of protective service and offering.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method, comprising:
providing, via a first party, private civil security resources comprising, at least in part:
civil security provisions;
civil security facilities; and
civil security services; and
knowingly permitting, by the first party, a second party to offer a product bundle comprising at least one second party product and at least partial payment for consideration-based access to the private civil security resources for potential authorized beneficiaries as an incentive for the potential authorized beneficiaries to obtain the at least one second party product.

2. The method of claim 1 wherein at least partial payment for consideration-based access to the private civil security resources further comprises offering to potential authorized beneficiaries substantially free access to at least a portion of the private civil security resources for obtaining the at least one second party product.

3. The method of claim 1 wherein at least partial payment for consideration-based access to the private civil security resources further comprises at least partial payment for access to the private civil security resources during a predetermined corresponding time period.

4. The method of claim 1 wherein at least partial payment for consideration-based access to the private civil security resources further comprises payment of a predetermined percentage of at least one of:
a one-time lump-sum payment;
a periodic fixed payment;
a periodic variable payment;
a barter exchange between the first and second parties;
civil security resources offered by bearer certificates associated with the first party.

5. The method of claim 1 wherein at least partial payment for access to the private civil security resources comprises providing at least one of:
a payment to cover any of the private civil security resources the potential authorized beneficiaries desire;
a payment to cover a predetermined selection of particular private civil security resources;
a payment to cover an option to access at least one predetermined package of private civil security resources.

6. The method of claim 1 further comprising at least one of:
compensating the first party, by the second party, by at least one of:
a direct payment to the first party;
a reimbursement payment to the potential authorized beneficiaries;
a payment to a third party accepting payments on behalf of the first party;
providing the first party with a promissory note;
bartering an exchange between the first and second parties.

7. The method of claim 1 further comprising:
in response to an applicable civilly-catastrophic event, permitting the potential authorized beneficiaries to access the private civil security resources as a function, at least in part, of the consideration-based access.

8. The method of claim 1 wherein the second party comprises at least one of:
a financial products institution;
a financial advisor;
a market maker;
a brokerage firm;
an insurance underwriter;
an insurance broker;
a bank;
a credit union;
an academic institution;
a club;
a certified financial planner;
a licensed securities dealer;
a religious organization;
a trade organization;
a fraternal organization;
a non-profit entity;
a business entity;
a manufacturer;
a product seller;
an inter-market entity;
an inter-dealer entity.

9. The method of claim 1 wherein the second party product is at least one of:
an insurance policy;
a financial product;
a financial investment product;
a financial savings product;
a financial planning product;
a financial service product;
a derivative financial product;
a legal services product;
a property investment product;
a debt product;
real estate;
a membership;
an extended warranty;
an advice-based product;
a commodity;
a product having a characteristic that suggests a relation to civil security resources;
a manufactured article;
a purchasable object;
a tradable object;
a household product;
a luxury;
a service.

10. The method of claim 1 wherein the second party is a financial services business, and wherein the product bundle is offered to the potential authorized beneficiaries for a minimum amount of funds deposited in an account managed by the financial services business.

11. The method of claim 10 wherein the second party product is at least one of:
a financial product;
a deposit account;
a checking account;
a saving account;
a money market fund;
a mutual fund;
a hedge fund;
a stock-based product;
a bond-based product.

12. The method of claim 1 wherein the second party is an insurance company and the second product is at least one of:
a life insurance policy;
a health insurance policy;
a disability care policy;
an asset insurance policy;
a home owner's policy;
a general liability policy;
a vehicular insurance policy;
a fire policy;
a natural disaster policy;
a business interruption policy;
an earthquake policy;
a flood policy;
a hurricane policy;
a tornado policy;
a terrorism policy;
an all-in-one insurance policy;
a worker's compensation policy;
a board of directors' liability, differences, errors, and omissions insurance policy;
an annuity plan.

13. The method of claim 1 further comprising:
permitting the authorized beneficiaries to access the private civil security resources after first determining that the authorized beneficiaries are presently authorized to access the private civil security resources.

14. The method of claim 1 further comprising:
compensating the first party with respect to permitting the authorized beneficiaries to access the private civil security resources after the first party provides notice to the second party regarding the authorized beneficiaries' access to the private civil security resources.

15. The method of claim 1 wherein the second party is partially, but not fully, owned by the first party.

16. The method of claim 1 further comprising:
permitting the potential authorized beneficiaries to acquire an additional quantity of the private civil security resources from the first party above an amount of the private civil security resources as is provided by the product bundle.

17. The method of claim 1 further comprising:
accepting, by the first party, at least one of: consideration-based subscriptions and policies for providing access to the private civil security resources.

18. The method of claim 1 wherein the access to the private civil security resources further comprises at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access;
option-based rights of access;
credit-based rights of access.

19. The method of claim 1 wherein the civil security provisions comprise at least one of:
a life-sustaining resource;
breathable air;
fluids;
water;
food;
protective clothing;
a shelter;
a medical supply;
a personal hygiene supply;
an environmental threat abatement supply;
a communications device;
an item for barter;
a luxury item.

20. The method of claim 1 wherein the civil security facilities comprise at least one of:
a civil security shelter;
a rally point at which the authorized beneficiaries can gather in response to a civilly-catastrophic event in order to receive the civil security services;
a location where at least some of the authorized beneficiary's civil security provisions are available;
a trans-shipment facility for at least some of the civil security provisions;
a medical services facility.

21. The method of claim 1 wherein the civil security services comprise at least one of:
transportation away from a location that substantially lacks civil security;
transportation to a civil security facility;
civil security information for the authorized beneficiaries;
civil security information that comprises contingency instructions to guide the authorized beneficiary during a time of need when responding to a civilly-catastrophic event;
civil security preparedness training;
a long distance communications service that is configured and arranged to provide persistent communication services notwithstanding interaction of the long distance communication service with effects of a civilly-catastrophic event;
a rescue service to retrieve selected beneficiaries from dangerous circumstances owing, at least in part, to a substantial lack of civil security;
delivery of at least a portion of the civil security provisions;
transport of dispossessed persons;
physical security;
medical services;
post-civilly-catastrophic event social relationship facilitation;
delivery of fuel;
installation of independent utilities facilities.

22. The method of claim 1 further comprising:
permitting the potential authorized beneficiaries to access the private civil security resources only in association with a civilly-catastrophic event, as a function, at least in part, of the consideration-based access, and
wherein the civilly-catastrophic event comprises an event that substantially disrupts society's infrastructure and ability to provide at least one life-sustaining resource.

23. The method of claim 22 wherein the civilly-catastrophic event is one that is likely to persist in substantial form for more than a predetermined period of time.

24. The method of claim 22 wherein the civilly-catastrophic event comprises at least one of:
a natural disaster;
a non-naturally-caused disaster.

25. The method of claim 24 wherein the natural disaster comprises at least one of:
a severe weather event;
a severe geophysical event;
a severe astronomical event;
a severe disease-based event;
a severe natural shortage of a life-sustaining resource.

26. The method of claim 24 wherein the non-naturally-caused disaster comprises at least one of:
an intentional act of aggression;
an unintentional act of aggression;
an unintended event that results in public dispersal of a severe environmentally borne danger;
relatively widespread risk of exposure to a mutagenic influence.

27. A method, comprising:
providing, via a first party, private civil security resources comprising, at least in part:
civil security provisions;
civil security facilities; and
civil security services;
offering, via a second party, a product bundle comprising at least one second party product and at least partial payment for consideration-based access to the private civil security resources for at least one potential authorized beneficiary as an incentive for the potential authorized beneficiary to obtain the at least one second party product.

28. A method, comprising:
providing, via a first party, private civil security resources comprising, at least in part:
civil security provisions;
civil security facilities; and
civil security services;
offering consideration-based access to the private civil security resources for potential authorized beneficiaries; and
offering at least one second party product to the potential authorized beneficiaries as an incentive for purchasing the consideration-based access to the private civil security resources.

29. The method of claim 28 wherein a second party providing the second party product is at least one of:
a financial products institution;
a financial advisor;
a market maker;
a brokerage firm;
an insurance underwriter;
an insurance broker;
a bank;
a credit union;
an academic institution;
a club;
a certified financial planner;
a licensed securities dealer;
a religious organization;
a trade organization;
a fraternal organization;
a non-profit entity;
a business entity;
a manufacturer;
a product seller.

30. The method of claim 28 wherein the second party product is at least one of:
an insurance policy;
a financial product;
a financial investment product;
a financial savings product;
a financial planning product;
a financial service product;
a derivative financial product;
a legal services product;
a property investment product;
a debt product;
real estate;
a membership;
an extended warranty;
an advice-based product;
a commodity;
a product having a characteristic that suggests a relation to civil security resources;
a manufactured article;
a purchasable object;
a tradable object;
a household product;
a luxury;
a service.

31. The method of claim 28 wherein offering at least one second party product comprises only offering the second party product with the purchase, by the potential authorized beneficiaries, of at least one of:
access to the private civil security resources for a minimum predetermined amount of time;
a minimum predetermined amount of the private civil security resources;
private civil security resources having at least a minimum predetermined cost;
a predetermined package of private civil security resources;
one of a plurality of offered different packages of private civil security resources;
a particular private civil security resource.

32. The method of claim 28 wherein offering at least one second party product comprises offering the second party product for free.

33. The method of claim 28 wherein acquiring the second party product is ordinarily based on a periodic payment, and wherein offering at least one second party product comprises offering to cover the periodic payment for the second party product for a predetermined time period.

34. The method of claim 28 wherein offering at least one second party product comprises offering to pay for the second party product by at least one of:
a one-time lump-sum payment;
a periodic fixed payment;
a periodic variable payment;
a barter exchange between the second party and the first party.

35. The method of claim 28 wherein offering at least one second party product comprises offering to pay a predetermined percentage of a cost of the second party product.

36. The method of claim 28 further comprising:
compensating, by the first party, a second party providing the second party product by at least one of:
a direct payment to the second party;
a reimbursement payment to the potential authorized beneficiaries;
a payment to a third party accepting payments on behalf of the second party.

37. The method of claim 28 further comprising:
permitting the potential authorized beneficiaries to access the private civil security resources only in association with an at least imminently threatened civilly-catastrophic event as a function, at least in part, of the consideration-based access.

38. The method of claim 28 wherein the second party is an insurance company and the second product is at least one of:
a life insurance policy;
a health insurance policy;
a disability care policy;
an asset insurance policy;
a home owner's policy;
a general liability policy;
a vehicular insurance policy;
a fire policy;
a natural disaster policy;
a business interruption policy;
an earthquake policy;
a flood policy;
a hurricane policy;
a tornado policy;
a terrorism policy;
an all-in-one insurance policy;
a worker's compensation policy;
a board of directors' liability, differences, errors, and omissions insurance policy;
an annuity plan.

39. The method of claim 28 wherein the second party is partially, but not fully, owned by the first party.

40. The method of claim 28 further comprising:
permitting the potential authorized beneficiaries to purchase additional private civil security resources above the amount of private civil security resources needed to obtain the second party product.

41. The method of claim 28 further comprising:
accepting at least one of: subscriptions and policies for access to the private civil security resources.

42. The method of claim 28 wherein the access is based on at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access;
option-based rights of access;
credit-based right of access.

43. The method of claim 28 wherein the civil security provisions comprise at least one of:
a life-sustaining resource;
breathable air;
fluids;
water;
food;
protective clothing;
a shelter;
a medical supply;
a personal hygiene supply;
an environmental threat abatement supply;
a communication device;
an item for barter;
a luxury item.

44. The method of claim 28 wherein the civil security facilities comprise at least one of:
a civil security shelter;
a rally point at which the authorized beneficiaries can gather in response to a civilly-catastrophic event in order to receive the civil security services;
a location where at least some of the authorized beneficiary's civil security provisions are available;
a trans-shipment facility for at least some of the civil security provisions;
a medical services facility.

45. The method of claim 28 wherein the civil security services comprise at least one of:
transportation away from a location that substantially lacks civil security;
transportation to a civil security facility;
civil security information for at least one of individual ones and any of the authorized beneficiaries;
civil security information that comprises contingency instructions to guide the authorized beneficiary during a time of need when responding to a civilly-catastrophic event;
civil security preparedness training;
a long distance communications service that is configured and arranged to provide persistent communication services notwithstanding interaction of the long distance communication service with effects of a civilly-catastrophic event;
a rescue service to retrieve selected beneficiaries from dangerous circumstances owing, at least in part, to a substantial lack of civil security;
delivery of at least a portion of the civil security provisions;
transport of dispossessed persons;
physical security;
medical services;
post-civilly-catastrophic event social relationship facilitation;
delivery of fuel;
installation of independent utilities facilities.

46. A method, comprising:
providing, via a first party, private civil security resources comprising, at least in part:
civil security provisions;
civil security facilities; and
civil security services; and
offering, via a second party, a bundle of services comprising at least one second party service and at least partial payment for consideration-based access to the private civil security resources for potential authorized beneficiaries as an incentive for the potential authorized beneficiaries to obtain the at least one second party product.

47. The method of claim 46, wherein the access to the private civil security resources are offered in the form of bearer certificates issued in association with the first party and corresponding to a predetermined at least one of: amount and kind of civil security resources.
